(19) United States
(12) Patent Application Publication
(10) Pub. No.: US 2006/0267289 A1
(43) Pub. Date: Nov. 30, 2006

(54) Hybrid abradable labyrinth damper seal

(75) Inventors: Jiming Li, Monroeville, PA (US); Pranabesh De Choudhury, Greensburg, PA (US)

Correspondence Address: THE WEBB LAW FIRM, P.C., 700 KOPPERS BUILDING, 436 SEVENTH AVENUE, PITTSBURGH, PA, 15219, US

(73) Assignee: ELLIOTT COMPANY, Jeannette, PA (US)

(21) Appl. No.: 10/560,802

(22) PCT Filed: Jun. 18, 2004
(86) PCT No.: PCT/US04/19596

§ 371 Date: May 12, 2006

Related U.S. Application Data
(60) Provisional application No. 60/480,722, filed on Jun. 20, 2003.

(51) Int. Cl. F16J 15/44

(52) U.S. Cl. 277/347

(57) ABSTRACT

An apparatus for restricting axial leakage flow along a rotating shaft comprises an abradable labyrinth seal and an adjacent damper seal. Normally, the abradable labyrinth is upstream of the damper seal and there is a plurality of labyrinth and damper seal segments adjacent and interleaved along the shaft.

### BACKGROUND OF THE INVENTION

Centrifugal compressors are rotating machines. They are comprised of stationary portions referred to as stators and rotating portions known as rotors. The rotors are supported on journal bearings in the stator. Differential gas pressure in the axial direction along the shaft tends to cause leakage flow along the shaft from higher to lower pressure regions. This leakage flow is detrimental for various reasons. Hence, seals are positioned along the shaft to restrict this leakage flow. In centrifugal compressors, use of labyrinth seals, and especially abradable labyrinth seals, are well known. Labyrinth seals provide a tortuous path along the shaft minimizing leakage flow. Generally, labyrinth seals comprise a plurality of radial teeth extending from the stator or the shaft with a small radial clearance at the tips of the teeth. In order to make the clearance very small and yet to accommodate the unavoidable vibration of the shaft relative to the stator which would result in the bouncing contact between the tip of the labyrinth teeth and the surface opposing the teeth, the surface is made of an abradable material such that in use, and depending on the vibrations encountered, the tips of the labyrinth teeth cut away grooves providing an additional clearance as shown, for example, in U.S. Pat. No. 6,203,021.

One of the detriments of leakage flow through labyrinth seals is that it can be the cause of rotor instability and vibration.

### SUMMARY OF THE INVENTION

Briefly, according to this invention, there is provided an apparatus for restricting axial leakage flow along a rotating shaft and improving rotor stability comprising an abradable labyrinth seal and an adjacent damper seal. The abradable labyrinth seal is upstream of the damper seal. Preferably, the apparatus comprises a plurality of labyrinth seal and damper seal segments which are adjacent and interleaved axially. The damper seals may be pocket seals, honeycomb seals, or hole pattern seals. According to one embodiment, the abradable labyrinth seal segment comprises a plurality of annular teeth extending from the shaft and an abradable stator section radially outward thereof.

According to an alternate embodiment according to this invention, there is provided an apparatus for restricting axial leakage flow along a rotating shaft and improving rotor stability which comprise the shaft having at least one toothed subsection from which annular teeth extend and at least one adjacent smooth land subsection. A cylindrical abradable surface is provided radially outward of the toothed subsection. A damping seal section is provided radially outward of the smooth land subsection of the shaft.

### BRIEF DESCRIPTION OF THE DRAWINGS

Further features and other objects and advantages will become clear from the following detailed description made with reference to the drawings in which:

FIG. 1 is a section view through a hybrid abradable labyrinth damper seal according to this invention;

FIG. 2 is a section view through an alternate hybrid abradable labyrinth damper seal according to this invention;

FIG. 3 is drawing of a non-abradable slotted pocket damper seal on stator;

FIG. 4 is an unwrapped view of a non-abradable honeycomb damper seal on stator; and

FIG. 5 is an unwrapped view of a non-abradable hole-pattern damper seal on stator.

### DESCRIPTION OF THE PREFERRED EMBODIMENTS

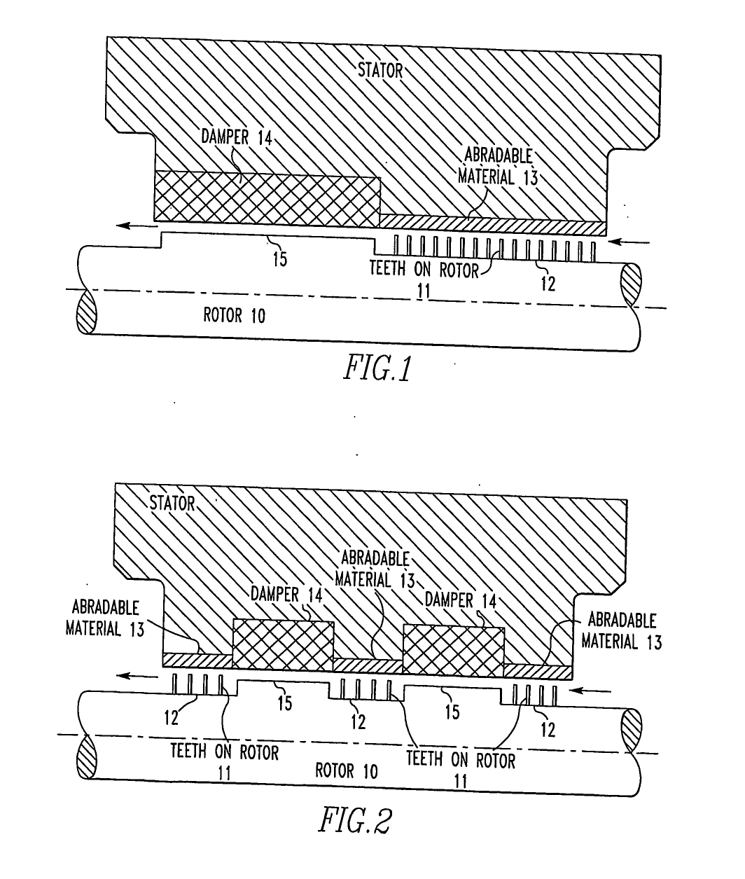

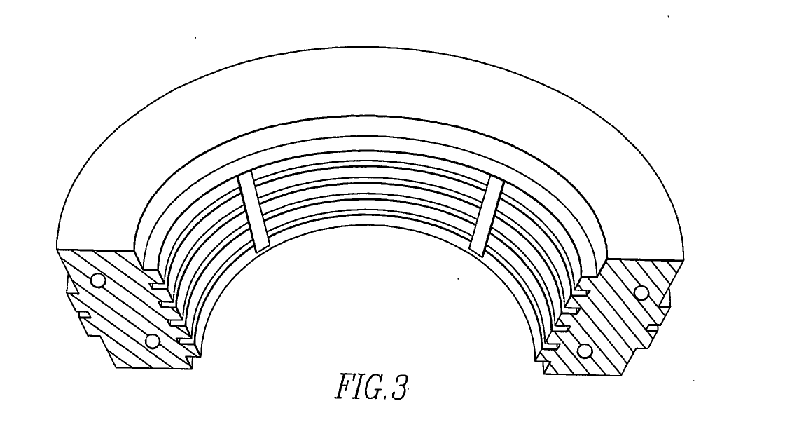

FIGS. 1 and 2 illustrate configurations of a hybrid abradable labyrinth damper seal. The teeth 11 on the rotor labyrinth section 12 restrict axial leakage flow effectively because abradable seal materials 13 permit tighter clearances. The damper section 14 over the smooth land section 15 provides the necessary damping and reduces the destabilizing cross-coupling forces.

Referring to FIG. 3, there is shown a non-abradable slotted pocket damper with teeth on the stator. The tip of the teeth of the pocket damper ride over smooth land sections 15 of the shaft 10 as seen in FIGS. 1 and 2. Partition walls divide annular grooves into several individual pockets and reduce the circumferential flow velocity in the seal. Tests have confirmed that the slotted pocket damper provides more effective damping than conventional labyrinth seals.

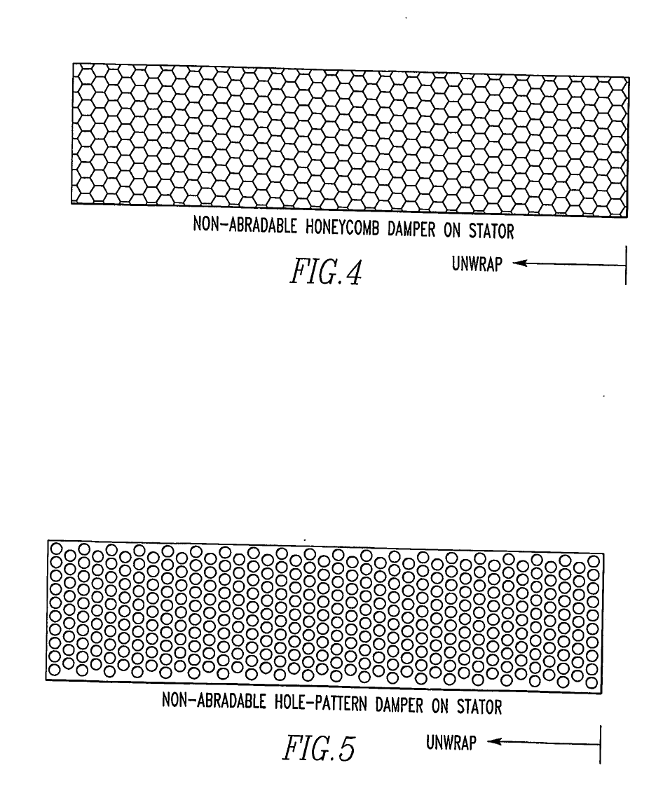

Referring to FIG. 4, there is shown a non-abradable honeycomb damper segment. The damper segment in use would be fixed to the stator over smooth land sections 15 of the shaft 10 as seen in FIGS. 1 and 2. Referring to FIG. 5, there is shown a non-abradable hole-pattern damper segment that may replace the honeycomb segment. Tests indicate that the honeycomb and hole-pattern dampers are superior to labyrinth seals in damping performance. The geometry of the pocket damper, honeycomb damper, or hole pattern damper can be optimized based on the seal operating conditions. The damper seals add positive damping into a high-speed rotor bearing system with an abradable (with tighter clearance) labyrinth seal section. The abradable damper seal section reduces the seal leakage, thus improving/keeping (without lowering) the compressor performance.

Experiments have confirmed that a slotted pocket damper provides more effective positive damping than conventional labyrinth seals. However, a pocket damper, when used by itself, requires larger clearances between the rotating shaft and pocket damper stator. This reduces the compressor performance which is undesirable. Honeycomb and hole-pattern stators could be used as damper segments in the hybrid abradable labyrinth damper seal. Test results indicate that honeycomb and hole-pattern dampers are superior to labyrinth seals in damping performance. However, honeycomb and hole-pattern dampers, when used alone, require larger clearances between the rotating shaft and the honeycomb or hole-pattern damper stator.

This invention keeps the desirable feature of low leakage through abradable labyrinth section, and introduces positive damping through the pocket damper, honeycomb, and hole-pattern damper section required to improve the rotor stability.

Having thus defined our invention with the detail and particularity required by the Patent Laws, what is desired protected by Letters Patent is set forth in the following claims.

The invention claimed is:

1. An apparatus for restricting axial leakage flow along a rotating shaft and providing necessary damping to improve rotor stability comprising an abradable labyrinth seal and a damper seal adjacent thereto.

2. The apparatus according to claim 1, wherein the abradable labyrinth is upstream of the damper seal.

3. The apparatus according to claim 1, wherein there is a plurality of labyrinth and damper seal segments adjacent and interleaved along the shaft.

4. The apparatus according to any one of claims 1 to 3, wherein the damper seal segment is selected from the group slotted pocket damper seals, honeycomb seals, and hole pattern seals.

5. The apparatus according to any one of claims 1 to 3, wherein the abradable labyrinth seal segment comprises a plurality of annular teeth extending from the shaft and an abradable stator section radially outward of said teeth.

6. An apparatus for restricting leakage flow along a rotating shaft and improving rotor stability comprising:
an axial section on the shaft having at least one toothed subsection having a plurality of annular teeth and at least one adjacent smooth subsection,
there being a cylindrical abradable stationary surface radially outward of the toothed subsection and a damping means radially outward of the smooth land subsection.

7. The apparatus according to claim 6, wherein the damping means is a slotted pocket damper seal.

8. The apparatus according to claim 6, wherein the damping means is selected from the group honeycomb seals and hole pattern seals.
